(19) United States
(12) Patent Application Publication
(10) Pub. No.: US 2012/0121320 A1
(43) Pub. Date: May 17, 2012

(54) Retaining Ring for Track Undercarriage Link Pin

(75) Inventors: Benoit Abello, Dunlap, IL (US); David J. Hakes, Brimfield, IL (US)

(73) Assignee: Caterpillar, Inc., Peoria (US)

(21) Appl. No.: 12/947,277

(22) Filed: Nov. 16, 2010

(51) Int. Cl. F16D 1/06; B23P 19/00

(52) U.S. Cl. 403/110; 29/426.1

(57) ABSTRACT

A track undercarriage link includes a bore for accommodating a pin. The bore may include an annular recess for accommodating part of a retaining ring. The pin may include a peripheral recess for accommodating part of the retaining ring as well. The retaining ring may include a strip that includes a first end and a second end. The strip may form at least one concentric ring with a gap disposed between the two ends. The gap may form a transition section that include a first section disposed adjacent the first end of the strip and a second section disposed adjacent the send end of the strip. A ramp may be disposed between the first and second sections. The ramp and the sections may enable a flathead screwdriver or other blunt object to be slid underneath the first or second end of the strip to facilitate removal of the retaining ring from the pin and therefore removal of the pin from the bore of the track undercarriage link.

### TECHNICAL FIELD

This disclosure relates generally to track machines and more specifically to improved links used in chains for track undercarriages for such track machines.

### BACKGROUND

Retaining rings are widely used in many fields to retain working elements on shafts or within cylinder bores. Retaining rings are used on cylindrical shafts to create a removable shoulder. Such retaining rings may be seated in a groove formed in the shaft, or they may grip the shaft in locations adjacent working elements. Retaining rings may also be used to create a removable shoulder within a bore that retains a plurality of working elements in place within the bore. In such instances, either the retaining rings may be seated in an inner, annular groove within the bore or otherwise grip the bore adjacent the working elements.

A track machine utilizes chains entrained about a sprocket, rollers, one or more idlers, and a track roller frame. The chain includes a plurality of links coupled by pins and bushings. Typically, one or two links are disposed on either side of the chain. The links disposed on opposite sides of the chain are normally coupled by a shoe. The shoes of the chain provide the needed traction for the track machine. A motor or an engine drives the sprocket, which engages bushings of the chain to move the chain around the track roller frame, thereby propelling the machine in the desired direction.

Typically, the chain includes a master link joint that allows assembly and disassembly of the chain by coupling the ends of the chain at the master link joint. While a “master link joint” is available in many forms, one prevalent design includes two pairs of “master links” disposed on either side of the chain. Each master link includes two “half links”, including a “first half link” and a “second half link”. A pin, rod or cartridge couples the first half link of one master link to the first half link of the other master link. A bushing couples the second half link of one master link to the second half link of the other master link. The bushing also engages the sprocket along with other bushings that couple links disposed on opposite sides of the chain. Threaded fasteners couple a shoe to all four half links of the two master links. Thus, a master link joint includes two master links, two first half links coupled by a pin, two second half links coupled by a bushing, and a shoe that is coupled to all four half links.

Typically, the pins are secured to their respective links using a swaging process. Both the pin and the link may be deformed by the swaging process. Therefore, use of the swaging process may result in an unserviceable pin and link and therefore the pin and link may need to be replaced if they become worn or damaged instead of being repaired. Therefore, a more efficient means for securing pins to links of a track undercarriage chain and more particularly, a more effective means for securing pins to master links of a chain of a track undercarriage are needed.

### SUMMARY OF THE DISCLOSURE

In one aspect, a retaining ring for a pin of an undercarriage link is disclosed. The retaining ring includes a strip that includes a first end and a second end. The strip forms at least one concentric ring with a gap disposed between the two ends and a transition section disposed in the gap. The transition section includes a first section disposed adjacent the first end of the strip, a second section disposed adjacent the second end of the strip and a ramp disposed between the first and second sections.

In another aspect, an undercarriage link is disclosed. The undercarriage link includes a bore for accommodating a pin. The bore may include an annular recess for accommodating part of a retaining ring. The pin may include a peripheral recess for accommodating part of the retaining ring as well. The retaining ring may include a strip including a first end and a second end. The strip may form at least one concentric ring with a gap disposed between the two ends.

In yet another aspect, a method for servicing a pin of a link of a track undercarriage chain is disclosed. The method includes providing link including a bore for accommodating the pin. The bore may include an annular recess for accommodating part of a retaining ring. The pin may also include a peripheral recess for accommodating part of the retaining ring. The retaining ring may include a strip including a first end and a second end. The strip may form at least one concentric ring with a gap disposed between the two ends. The retaining ring may be disposed partially in the annular recess of the bore and partially in the peripheral recess of the pin. The method includes engaging one of the first or second ends of the strip with a flathead screwdriver or other blunt instrument, prying the retaining ring out of the annular and peripheral recesses and removing the pin from the bore.

In any one or more of the aspects described above, the ramp and first section of the retaining ring may accommodate a flathead screwdriver or other blunt object for obtaining a purchase or grip on the first end of the strip. Similarly, the ramp and second section may accommodate a flathead screwdriver or other blunt object for obtaining a purchase on the second end of the strip for purposes of removing the retaining ring. In combination with any one or more of the aspects described above, the strip of the retaining ring may form less than two concentric rings. In combination with any one or more of the aspects described above, the strip of the retaining ring may extend along a concentric path ranging from about 660° to about 700°. In combination with any one or more of the aspects described above, the strip of the retaining ring may be metallic and the strip may be flat. In combination with any one or more of the aspects described above, the strip has a thickness ranging from about 1.5 to about 4 mm (about 0.05906 to about 0.1575 inch) and a width ranging from about 3 to about 5.5 mm (about 0.1181 to about 0.2165 inch). In combination with any one or more of the aspects described above, the strip has a thickness ranging from about 2.75 to about 3.75 mm (about 0.1083 to about 0.1476 inch) and a width ranging from about 4.3 to about 5.3 mm (about 0.1693 to about 0.2087 inch).

### BRIEF DESCRIPTION OF THE DRAWINGS

FIG. 1 is a partial view of a link of a track undercarriage chain, particularly illustrating the location of a pin within a bore and held in place with a disclosed retaining ring;

FIG. 2 is another partial view of a link of a track undercarriage chain particularly illustrating a disclosed retaining ring holding a pin in place;

FIG. 3 is another partial view of a link of a track undercarriage chain, particularly illustrating an annular recess for accommodating part of a disclosed retaining ring;

FIG. 4 is a perspective view of a disclosed retaining ring;

FIG. 5 is another perspective view of a disclosed retaining ring;

FIG. 6 illustrates, sequentially, an installation of a disclosed retaining ring in a peripheral groove of a pin accommodated in a bore of a link of a track undercarriage chain;

FIG. 7 is a sectional and schematic illustration of the insertion of a disclosed retaining ring in the annular recess of a link and the peripheral recess of a pin.

FIG. 8 is a sectional view of a link and pin prior to installation of a disclosed retaining ring.

FIG. 9 is a perspective and sectional view of the link and pin of FIG. 8 illustrating an initial insertion of the disclosed retaining ring in the annular recess disposed between the pin and the link.

FIG. 10 is another perspective and sectional view of the link, pin and ring shown in FIG. 9 with the disclosed retaining ring disposed in the peripheral recess of the pin in between the peripheral recess of the pin and the annular recess of the link.

FIG. 11 is a perspective view of the pin, link and ring shown in FIG. 10.

### DETAILED DESCRIPTION

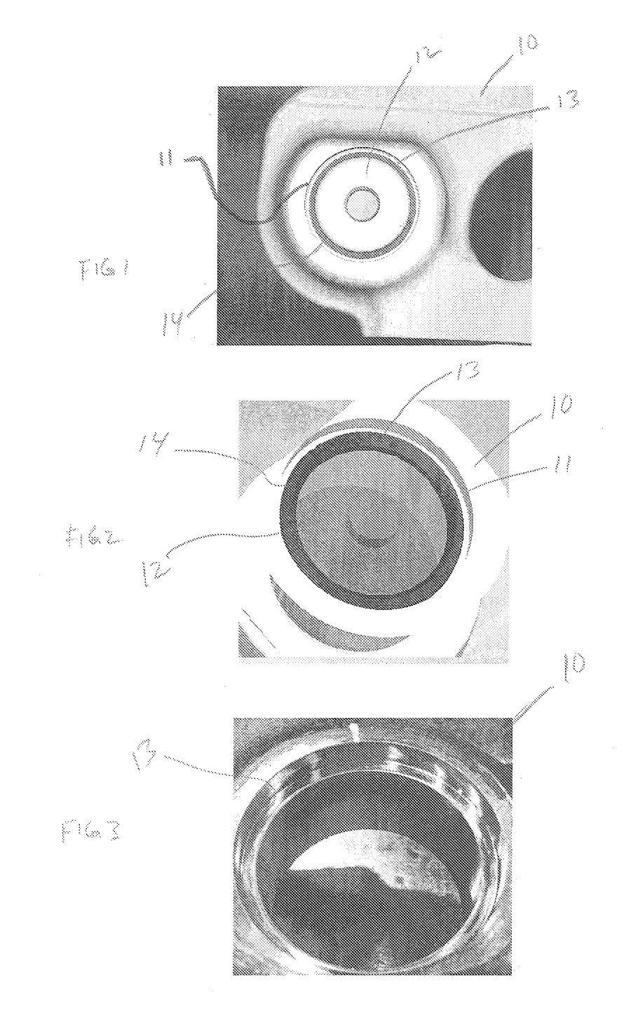

Referring to FIG. 1, a partial view of a chain link 10 is shown with a bore 11 that accommodates a pin 12. The bore 11 includes an annular recess 13 in which a retaining ring 14 is partially disposed.

For example, referring to FIG. 2, another partial view of the chain link 10 is shown with a bore 11 that includes annular recess 13. A disclosed retaining ring 14 is at least partially disposed in the annular recess 13. As explained in greater detail below, the retaining ring 14 may also be partially disposed in a peripheral recess 26 of the pin 12 (see FIG. 6.)

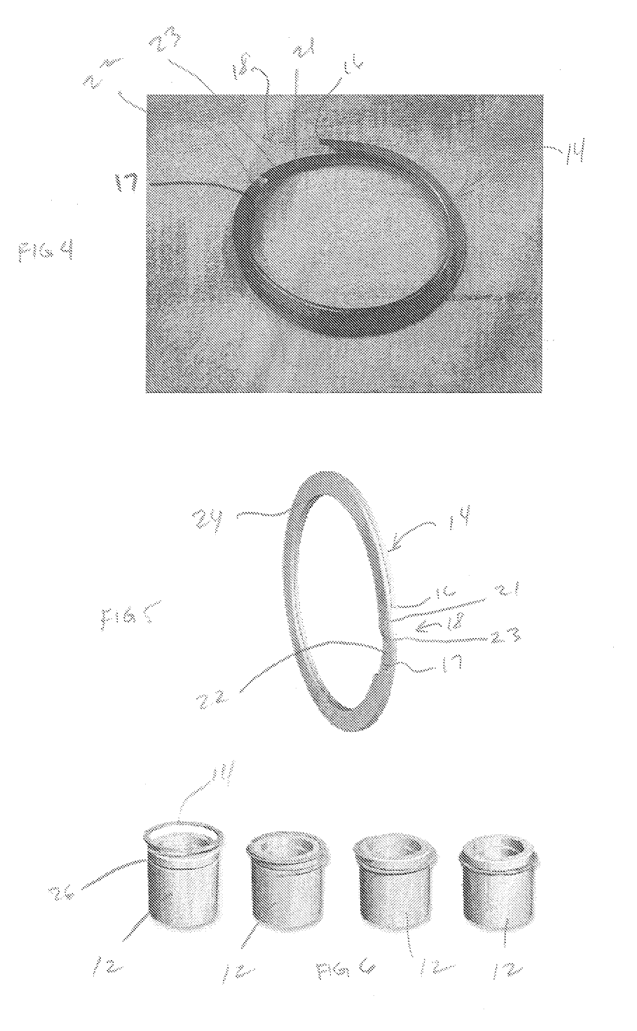

FIG. 3 is another partial illustration of a chain link 10, particularly illustrating the annular recess 13. FIGS. 4 and 5 illustrate a disclosed retaining ring 14. The retaining ring 14 may include a first end 16, a second end 17 and a gap 18 disposed there between. The gap 18 includes a first section 21, a second section 22 and a ramp 23 disposed there between. The combination of the ramp 23 and the first section 21 enables a flathead screwdriver or other blunt instrument (not shown) to be slid under the first end 16 of the retaining ring 14 when removing the retaining ring 14. Similarly, the combination of the ramp 23 and second section 22 enables a flathead screwdriver or other blunt instrument to be slid underneath the second end 17 of the retaining ring 14 for removal of the retaining ring 14.

As seen in FIGS. 4 and 5, the ring may include less than two concentric circles. Specifically, the retaining ring 14 may be fabricated from a strip 24 that forms less than two concentric circles or, in other words, has a concentric rotation that ranges from about 660° to about 700°.

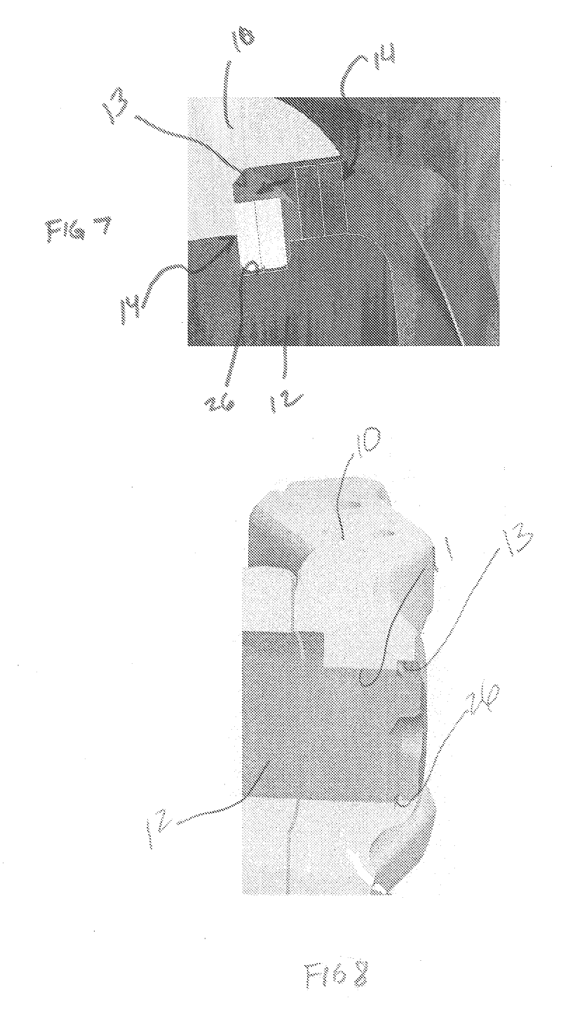

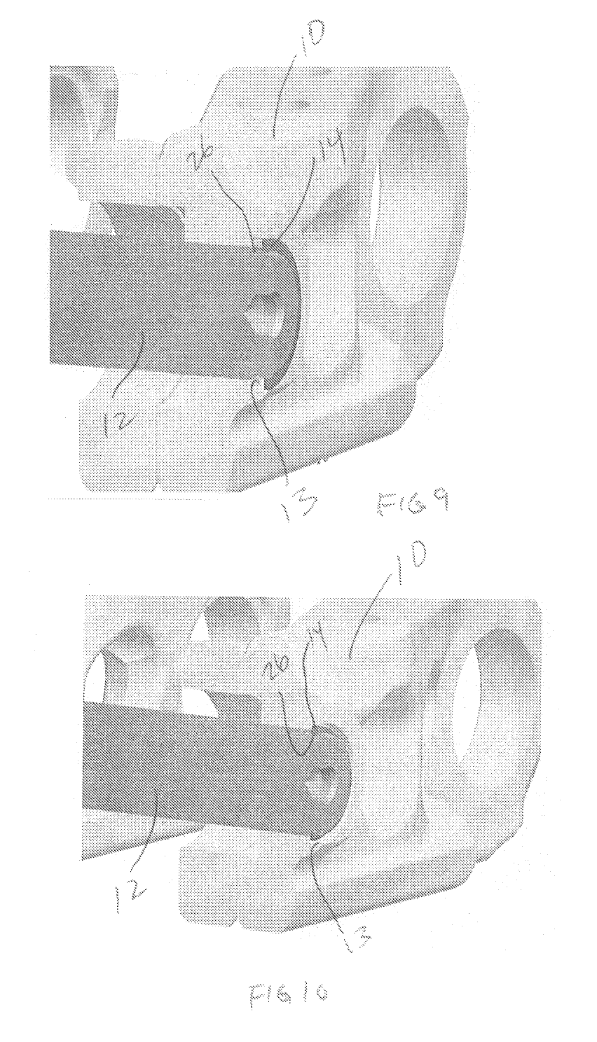

FIG. 6 illustrates a sequential installation of a retaining ring 14 in a peripheral recess 26 of a pin 12. FIG. 7 illustrates the placement of a disclosed retaining ring 14 into the peripheral recess 26 of the pin 12 and the annular recess 13 of the chain link 10.

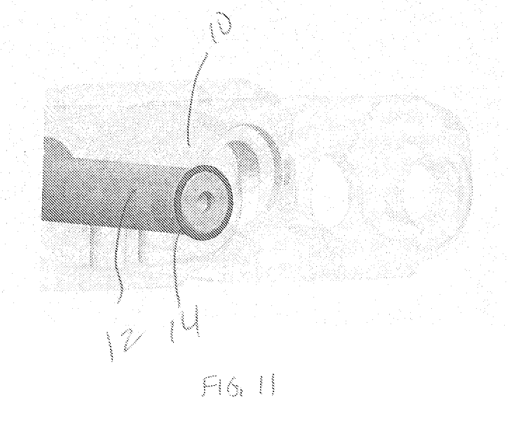

Turning to FIGS. 8-11, FIG. 8 is a sectional view illustrating a pin 12 as inserted into a link 10. The link 10 includes an annular recess 13 and the pin 12 includes a peripheral recess 26. The disclosed retaining ring 14 is to be secured in the peripheral recess 26 of the pin and between the peripheral recess 26 an annular recess 13. FIG. 9 is a perspective and sectional view illustrating an initial insertion of the ring 14 in the annular recess 13 of the link 10 and before ring 14 reaches the peripheral recess 26 of the pin 12. FIG. 10 illustrates the completion of this process as the ring 14 is disposed in the peripheral recess 26 and is sandwiched between the peripheral recess 26 and annular recess 13 of the link 10. The ring 14 engages the link 10 thereby preventing forward movement of the pin 12 out of the link 10. FIG. 11 is a partial perspective view of the installed retaining ring 14, pin 12 and link 10.

### INDUSTRIAL APPLICABILITY

A retaining ring for a pin of an undercarriage link is disclosed that provides an effective alternative to the currently employed swaging processes. The retaining ring may include a strip including a first end and a second end. The strip may form at least one concentric ring with a gap disposed between two ends and a transition section disposed in the gap. The transition section may include a first section disposed adjacent the first end of the strip and a second section disposed adjacent the second end of the strip. A ramp may be disposed between the first and second section that facilitate the insertion of a screwdriver or other blunt object beneath one of the ends for removal of the ring and therefore removal of the pin from the chain link. The chain link may be part of a chain of a typical track undercarriage link or it may also be a master link. The techniques disclosed herein apply to other types of chains and chain links as well.

A method for servicing a pin of the link of a track undercarriage is also disclosed. The method includes providing an undercarriage chain link with a bore for accommodating a pin. The bore may include an annular recess for accommodating part of a retaining ring. The pin may include a peripheral recess for accommodating part of the retaining ring as well. The retaining ring includes a strip including a first end and a second end. The strip may form at least one concentric ring with a gap disposed between the two ends of the strip. The retaining ring may be disposed partially in the annular recess of the bore of the chain link and partially in the peripheral recess of the pin. The method of servicing may include engaging one of the first or second ends of the strip with a flathead screwdriver or other blunt instrument, prying the retaining ring out of the annular and peripheral recesses and removing the pin from the bore.

The use of the disclosed retaining ring, the annular recess of the link and pin with the peripheral recess exhibit create abilities to withstand axial loads comparable to that of conventional pins that are connected to a link by swaging. For example, a swaged pin can withstand an axial load ranging from about 100 to about 110 kN. In contrast, a pin held in place in a bore of a chain link with a disclosed retaining ring having a thickness of about 1.93 mm (about 0.07598 inch) and a width of about 4.8 mm (about 0.189 inch) can withstand an axial load ranging from about 75 to about 80 kN. Similarly, a pin held in place in a bore of a chain link with a disclosed retaining ring having a thickness of about 3.25 mm (about 0.128 inch) and a width of about 4.8 mm (about 0.189 inch) can withstand an axial load exceeding 80 kN and approaching 90 kN.

The disclosed retaining rings, annular recesses in the chain links and peripheral recesses in the pins also exhibit the ability to withstand cyclic loads comparable to a swaged pin/link connection. For example, a typical swaged pin and link can withstand an average maximum cyclic load ranging from about 50 to about 60 kN. Similarly, a pin held in place by a retaining ring having a thickness of about 1.93 mm (about 0.07598 inch) and a width of about 4.8 mm (about 0.189 inch) can withstand an average maximum cyclic load of about 40 kN. Pins held in place by retaining rings having a thickness of about 3.25 mm (about 0.128 inch) and a width of about 4.8 mm (about 0.189 inch) can withstand such an average maximum cyclic load exceeding 50 kN. Pins held in place by retaining rings having a thickness of about 1.98 mm (about 0.07795 inch) and width of about 3.58 mm (about 0.1409 inch) can withstand an average maximum cyclic load exceeding 45 kN. Pins held in place by retaining rings having a thickness of about 3.25 mm (about 0.128 inch) and a width of about 3.53 mm (about 0.139 inch) can withstand such an average maximum cyclic load of about 40 kN.

Experimental results are illustrated in Table 1:

TABLE 1

| | No. of Cycles | Load Case at | Axial Load | Cyclic Load | With | |
|---|---|---|---|---|---|---|
| Specimen ID | at Failure | Failure | (kN) | (kN) | oil/grease | Retaining Ring |
| Swage-101 | 295/60296 | 21 | 88.96 | 53.38/−26.69 | | Swage |
| Swage-102 | 209/48209 | 21 | 88.96 | 53.38/−26.69 | | Swage |
| Swage-103 | 38/81039 | 32 | 133.45 | 62.28/−31.14 | | Swage |
| Swage-104 | 806/60807 | 21 | 88.96 | 53.38/−26.69 | | Swage |
| Swage-105 | 40/93041 | 32 | 133.45 | 62.28/−31.14 | | Swage |
| Retaining Ring- | 78/60079 | 21 | 88.96 | 53.38/−26.69 | oil | DNS 54 (1.93 mm × 4.8 mm) |
| Retaining Ring- | 0/39001* | 14 | 67.2 | 26.69/−13.34 | grease | DNS 54 (1.93 mm × 4.8 mm) |
| Retaining Ring- | 0/60001* | 21 | 88.96 | 53.38/−26.69 | oil | (3.25 mm × 4.8 mm) |
| Retaining Ring- | 0/60001* | 21 | 88.96 | 53.38/−26.69 | grease | (3.25 mm × 4.8 mm) |
| Retaining Ring- | 38/60039 | 21 | 88.96 | 53.38/−26.69 | oil | WST-212 (1.98 mm × 3.58 mm) |
| Retaining Ring- | 0/21001* | 8 | 22.24 | 44.48/−22.24 | grease | WST-212 (1.98 mm × 3.58 mm) |
| Retaining Ring- | 0/9001* | 4 | 11.12 | 44.48/−22.24 | oil | (3.25 mm × 3.53 mm) |
| Retaining Ring- | 0/60001* | 3 | 11.12 | 35.591-17.79 | grease | (3.25 mm × 3.53 mm) |
| Retaining Ring- | 0/9001* | 4 | 11.12 | 44.48/−22.24 | oil | No ring installed |

*Exact cycle count at failure not known.

As seen from Table 1, retaining rings with a 3.25 mm thickness and a 4.8 mm width perform exceptionally well in comparison to pins that are held in place by swaging. Table 2 below illustrates the exceptional performance of such retaining rings in terms of axial and cyclical loads. A radial load was applied to a cantilevered end of a pin at a cycle of about 1 Hz. A radial force in a positive direction was applied that it was twice the radial force in the negative direction, beginning at +1814 kilograms (4,000 lbs)/−907.2 kilograms (−2,000 lbs). Axial loads were applied to the end face of the pin that was pressed into the link bore and held in place by one of the disclosed retaining rings. The initial axial load was 1134 kilograms (2,500 lbs) (see load cases 1-4) while subsequent increments were increased by 2268 kilograms (5,000 lbs) (see load cases 5-8, 9-12, 13-16, 17-21, 22-26, and 27-32).

TABLE 2

| | | Axial Load | Cyclic Load |
|---|---|---|---|
| Load Case | # of Cycles | (kN) | (kN) |
| 1 | 3000 | 11.12 | +17.79/−8.9 |
| 2 | 3000 | 11.12 | +26.69/−13.34 |
| 3 | 3000 | 11.12 | +35.59/−17.79 |
| 4 | 3000 | 11.12 | +44.48/−22.24 |
| 5 | 3000 | 22.24 | +17.79/−8.9 |
| 6 | 3000 | 22.24 | +26.69/−13.34 |
| 7 | 3000 | 22.24 | +35.59/−17.79 |
| 8 | 3000 | 22.24 | +44.48/−22.24 |
| 9 | 3000 | 44.48 | +17.79/−8.9 |
| 10 | 3000 | 44.48 | +26.69/−13.34 |
| 11 | 3000 | 44.48 | +35.59/−17.79 |
| 12 | 3000 | 44.48 | +44.48/−22.24 |
| 13 | 3000 | 67.20 | +17.79/−8.9 |
| 14 | 3000 | 67.20 | +26.69/−13.34 |
| 15 | 3000 | 67.20 | +35.59/−17.79 |
| 16 | 3000 | 67.20 | +44.48/−22.24 |
| 17 | 3000 | 89.60 | +17.79/−8.9 |
| 18 | 3000 | 89.60 | +26.69/−13.34 |
| 19 | 3000 | 89.60 | +35.59/−17.79 |
| 20 | 3000 | 89.60 | +44.48/−22.24 |
| 21 | 3000 | 89.60 | +53.38/−26.69 |
| 22 | 3000 | 111.21 | +17.79/−8.9 |
| 23 | 3000 | 111.21 | +26.69/−13.34 |
| 24 | 3000 | 111.21 | +35.59/−17.79 |
| 25 | 3000 | 111.21 | +44.48/−22.24 |
| 26 | 3000 | 111.21 | +53.38/−26.69 |
| 27 | 3000 | 133.45 | +17.79/−8.9 |
| 28 | 3000 | 133.45 | +26.69/−13.34 |
| 29 | 3000 | 133.45 | +35.59/−17.79 |
| 30 | 3000 | 133.45 | +44.48/−22.24 |
| 31 | 3000 | 133.45 | +53.38/−26.69 |
| 32 | 3000 | 133.45 | +62.28/−31.14 |
| 1 | 3000 | 11.12 | +17.79/−8.9 |
| 2 | 3000 | 11.12 | +26.69/−13.34 |
| 3 | 3000 | 11.12 | +35.59/−17.79 |
| 4 | 3000 | 11.12 | +44.48/−22.24 |
| 5 | 3000 | 22.24 | +17.79/−8.9 |
| 6 | 3000 | 22.24 | +26.69/−13.34 |
| 7 | 3000 | 22.24 | +35.59/−17.79 |
| 8 | 3000 | 22.24 | +44.48/−22.24 |
| 9 | 3000 | 44.48 | +17.79/−8.9 |
| 10 | 3000 | 44.48 | +26.69/−13.34 |
| 11 | 3000 | 44.48 | +35.59/−17.79 |
| 12 | 3000 | 44.48 | +44.48/−22.24 |
| 13 | 3000 | 67.20 | +17.79/−8.9 |
| 14 | 3000 | 67.20 | +26.69/−13.34 |
| 15 | 3000 | 67.20 | +35.59/−17.79 |
| 16 | 3000 | 67.20 | +44.48/−22.24 |
| 17 | 3000 | 89.60 | +17.79/−8.9 |
| 18 | 3000 | 89.60 | +26.69/−13.34 |
| 19 | 3000 | 89.60 | +35.59/−17.79 |
| 20 | 3000 | 89.60 | +44.48/−22.24 |
| 21 | 3000 | 89.60 | +53.38/−26.69 |
| 22 | 3000 | 111.21 | +17.79/−8.9 |
| 23 | 3000 | 111.21 | +26.69/−13.34 |
| 24 | 3000 | 111.21 | +35.59/−17.79 |
| 25 | 3000 | 111.21 | +44.48/−22.24 |
| 26 | 3000 | 111.21 | +53.38/−26.69 |
| 27 | 3000 | 133.45 | +17.79/−8.9 |
| 28 | 3000 | 133.45 | +26.69/−13.34 |
| 29 | 3000 | 133.45 | +35.59/−17.79 |
| 30 | 3000 | 133.45 | +44.48/−22.24 |
| 31 | 3000 | 133.45 | +53.38/−26.69 |
| 32 | 3000 | 133.45 | +62.28/−31.14 |

In summary, an improved means for securing a link pin in place within a bore of a track or chain link is shown and described. The use of the disclosed retaining ring and annular and/or peripheral groove system provides a structure that is competitive in terms of strength and durability with a swaged structure yet provides a structure that is serviceable and repairable as opposed to being merely replaceable.

From Table 1, exceptional retaining rings have thickness of about 3.25 mm (about 0.128 inch) and about 1.98 mm (about 0.07795 inch) and widths of about 4.8 mm (about 0.189 inch) and about 3.58 mm (about 0.1409 inch) respectively. Thus, suitable dimensions for the disclosed retaining rings can range from about 1.5 to about 4 mm (about 0.05906 to about 0.1575 inch) and suitable widths can range from about 3 to about 5.5 mm (about 0.1181 to about 0.2165 inch). It will be noted from Table 1 that the retaining rings having thicknesses of about 3.25 mm (about 0.128 inch) and widths of about 4.8 mm (about 0.189 inch) were less sensitive to grease or oil and therefore provide exceptional performance. Thus, more narrowly, suitable retaining rings may have thicknesses ranging from about 2.75 to about 3.75 mm (about 0.1083 to about 0.1476 inch) and widths ranging from about 4.3 to about 5.3 mm (about 0.1693 to about 0.2087 inch).

What is claimed is:

1. A retaining ring for a pin of an undercarriage link, the retaining ring comprising:
a strip including a first end and a second end, the strip forming at least one concentric ring with a gap disposed between the first and second ends and a transition section disposed in the gap,
the transition section including a first section disposed adjacent the first end of the strip, a second section disposed adjacent the second end of the strip and a ramp disposed between the first and second sections.

2. The retaining ring of claim 1 wherein the ramp and first section can accommodate a flat head screwdriver or other blunt object for obtaining a purchase on the first end of the strip.

3. The retaining ring of claim 1 wherein the ramp and second section can accommodate a flat head screwdriver or other blunt object for obtaining a purchase on the second end of the strip.

4. The retaining ring of claim 1 the strip forms less than two concentric rings.

5. The retaining ring of claim 1 wherein the strip extends along a concentric path ranging from about 660° to about 700°.

6. The retaining ring of claim 1 wherein the strip has a thickness ranging from about 1.5 to about 4 mm and a width ranging from about 3 to about 5.5 mm.

7. The retaining ring of claim 1 wherein the strip has a thickness ranging from about 2.75 to about 3.75 mm and a width ranging from about 4.3 to about 5.3 mm.

8. A track undercarriage link comprising:
a bore for accommodating a pin, the bore including an annular recess for accommodating part of a retaining ring;
the pin including a peripheral recess for accommodating part of the retaining ring;
the retaining ring including a strip including a first end and a second end, the strip forming at least one concentric ring with a gap disposed between the two ends.

9. The link of claim 8 further including a transition section disposed in the gap, the transition section including a first section disposed adjacent the first end of the strip, a second section disposed adjacent the second end of the strip and a ramp disposed between the first and second sections.

10. The link of claim 9 wherein the ramp and first section can accommodate a flat head screwdriver or other blunt object for obtaining a purchase on the first end of the strip.

11. The link of claim 9 wherein the ramp and second section can accommodate a flat head screwdriver or other blunt object for obtaining a purchase on the second end of the strip.

12. The link of claim 8 the strip forms less than two concentric rings.

13. The link of claim 8 wherein the strip extends along a concentric path ranging from about 660° to about 700°.

14. The link of claim 8 wherein the strip has a thickness ranging from about 1.5 to about 4 mm and a width ranging from about 3 to about 5.5 mm.

15. The link of claim 8 wherein the strip has a thickness ranging from about 2.75 to about 3.75 mm and a width ranging from about 4.3 to about 5.3 mm.

16. The link of claim 8 wherein the link forms part of a master link.

17. A method for servicing a pin of a link of a track undercarriage, the method comprising:
providing the undercarriage link including a bore for accommodating the pin, the bore including an annular recess for accommodating part of a retaining ring, the pin including a peripheral recess for accommodating part of the retaining ring, the retaining ring including a strip including a first end and a second end, the strip forming at least one concentric ring with a gap disposed between the two ends, the retaining ring disposed partially in the annular recess and partially in the peripheral recess;
engaging one of the first or second ends of the strip with a flathead screwdriver or other blunt instrument;
prying the retaining ring out of the annular and peripheral recesses; and
removing the pin from the bore.

18. The method of claim 17 wherein the retaining ring further including a transition section disposed in the gap, the transition section including a first section disposed adjacent the first end of the strip, a second section disposed adjacent the second end of the strip and a ramp disposed between the first and second sections, and
the method further includes sliding a flathead screwdriver or other blunt instrument along the ramp and under one of the first or second ends of the strip.

19. The method of claim 17 wherein the link is part of a master link.

20. The method of claim 17 wherein the strip extends along a concentric path ranging from about 660° to about 700°.
